(19) United States
(12) Patent Application Publication
(10) Pub. No.: US 2009/0023582 A1
(43) Pub. Date: Jan. 22, 2009

(54) CATALYST AND PROCESS FOR ITS MANUFACTURE

(76) Inventors: Bruce MacDonald Lacey, Knoxville, TN (US); Steven Lynn McMahon, Sevierville, TN (US); Ding Jun Wang, Sewell, NJ (US)

Correspondence Address: RATNERPRESTIA, P.O. BOX 980, VALLEY FORGE, PA, 19482, US

(21) Appl. No.: 11/917,876

(22) PCT Filed: Jun. 15, 2006
(86) PCT No.: PCT/GB06/50157

§ 371 Date: Oct. 6, 2008

Related U.S. Application Data
(60) Provisional application No. 60/690,960, filed on Jun. 16, 2005.

(51) Int. Cl. B01J 23/89

(52) U.S. Cl. 502/304; 502/327

(57) ABSTRACT

The inventive catalyst composition is a sponge metal catalyst comprising at least one skeletal porous sponge metal selected from the group consisting of nickel, cobalt, iron and copper, together with a first promoter metal selected from the group consisting of palladium, platinum, ruthenium, rhodium, osmium and iridium and a second promoter metal selected from the group consisting of iron, nickel, cobalt, zinc, vanadium, cerium, copper, tungsten, molybdenum, titanium, niobium, manganese, silver, cadmium, praseodymium and neodymium. Processes for the manufacture of the catalyst include impregnation or precipitation of the promoter metals onto the sponge metal catalyst.

The present invention concerns an improved sponge metal catalyst and a process for its manufacture.

Sponge metal catalysts are well known for use in hydrogenation, for example for hydrogenation of aromatic nitro compounds or of nitriles to organic amines. Sponge metal catalysts are typically made by forming an alloy of the catalytic metal, for example nickel or cobalt, with a leachable metal such as aluminium and then removing the aluminium, usually by reaction and dissolution of the aluminium in a sodium hydroxide solution. The resulting catalytic metal is then in the form of a sponge structure having a high surface area and good activity and selectivity for many commercial hydrogenation processes.

It is known to modify the activity and selectivity of sponge metal catalysts by the incorporation of a second or subsequent metal as a promoter. For example, US-A-3997478 describes sponge-nickel catalysts containing as promoter at least two metals selected from the group consisting of chromium, cobalt, molybdenum and manganese. FR-A-2722710 describes a catalyst for the hydrogenation of nitriles to amines of a Raney-nickel-type doped with at least one additional metallic element selected from groups IVB, VB and VIB. The Raney nickel is placed in suspension in a solution of the additive element. US-A-5840989 describes a method of doping a Raney™ nickel catalyst doped with metals by the incorporation of the doping metals in the form of a complex into the alkaline attack medium. The doping metals are preferably chosen from titanium, chromium, zirconium, vanadium, molybdenum, manganese or zinc. Also disclosed is a process for the hydrogenation of nitriles to amines using the catalyst. US-B-6,309,758 describes a precious metal doped porous metal catalyst is disclosed in which the precious metal is present in from 0.01 to 1.5 weight percent and distributed throughout the particles of porous metal to provide a surface to bulk ratio distribution of not greater than 60. EP-A-0880996 describes a formed metal solid-bed catalyst, consisting entirely of catalyst alloy (and up to 15 wt % chromium, iron, cobalt, tantalum, molybdenum and/or titanium as promoters) with a total pore vol. of 0.1-0.6 ml/g and with a surface shell 0.1-2.0 mm thick which is activated by complete or partial leaching of an extractable alloy component.

We have now found an improved sponge metal catalyst and preparation method therefor.

According to the invention we provide a catalyst composition comprising at least one skeletal porous sponge metal selected from the group consisting of nickel, cobalt, iron and copper, a first promoter metal selected from the group consisting of palladium, platinum, ruthenium, rhodium, osmium and iridium and a second promoter metal selected from the group consisting of iron, nickel, cobalt, zinc, vanadium, cerium, copper, tungsten, molybdenum, titanium, niobium, manganese, silver, cadmium, praseodymium and neodymium. We have found that the use of a combination of the first and second promoter metals is surprisingly more effective than the use of similar promoters alone.

We further provide a method for the manufacture of a catalyst composition comprising the steps of:
a) forming a sponge metal catalyst in which the active skeletal metal is selected from at least one of nickel, cobalt, iron and copper
b) depositing upon the surface of said sponge metal catalyst at least one compound of a metal selected from the group consisting of palladium, platinum, ruthenium, rhodium, osmium and iridium and
c) depositing upon the surface of said sponge metal catalyst at least one compound of a metal selected from the group consisting of iron, nickel, cobalt, zinc, vanadium, cerium, copper, tungsten, molybdenum, titanium, niobium, manganese, silver, cadmium, praseodymium and neodymium.

By active skeletal metal we mean the catalytically active metal which is alloyed with a leachable metal and which is left behind when the leachable metal is dissolved and removed from the alloyed material. The active skeletal metal is in the form of a highly porous sponge structure having a high surface area. The active skeletal metal is selected from nickel, copper, cobalt and iron and may comprise more than one of these metals.

Preferred first promoter metals comprise Pt, Pd and Rh. Preferred second promoter metals comprise V, Fe, Ce and Zn.

The catalyst of the invention is based on a sponge-metal catalyst which is of the type well-known in the art and which is formed using known methods. To form the sponge metal catalyst, first, an alloy is formed having from about 30 to 60 (preferably from about 42 to 56) weight percent of the active skeletal metal, i.e. nickel cobalt, iron and/or copper and from about 70 to 40 (preferably from about 58 to 44) weight percent of a leachable metal. The leachable metal is preferably selected from aluminium or silicon but is most preferably aluminium. Other metals such as titanium, chromium, zirconium, vanadium, molybdenum, manganese or zinc may, optionally, be present in an amount up to about 20%, more preferably from 5-15% of the skeletal metal weight. The alloy is crushed and ground into particles having an average particle size of less than 500 μm diameter, preferably less than 75 μm diameter, more preferably less than 50 μm diameter. The resulting catalyst precursor is activated by leaching the aluminium from the alloy with an alkali solution, such as an aqueous solution of sodium hydroxide (preferred) or potassium hydroxide. The alkali is used at a concentration from 15 to 35 and most preferably from 20 to 35 weight percent, commonly about 30%. The aluminium dissolves in the alkali to form an alkali metal aluminate, which is soluble in water. The leaching can be carried out at ambient temperature but preferably is conducted at elevated temperatures, e.g. from about 40° C. to 110° C., particularly about 90° C. to promote a high rate of leaching and removal of the aluminium metal from the alloy to leave the skeletal metal in a highly active form. The leaching is normally carried out over a period of several hours, e.g. from about 2 to about 8 hours. The time taken is, however dependent upon the conditions selected. This process is already well known to the skilled person.

When the present catalyst is contemplated for use in fixed bed reactors, the porous, particulate base metal product may have an average particle size diameter (or largest dimension) of from about 0.1 to 0.8 cm. The alloy is leached with an alkali solution described above having an alkali concentration of from about 5 to 35 weight percent, preferably from about 5 to 20 weight percent. The leaching is normally carried out at elevated temperatures of from about 30° C. to about 90° C., preferably from about 30 to 50° C.

The resulting sponge metal catalyst particles therefore comprises from 80-95% of the active skeletal metal and may additionally contain some of the leachable metal, e.g. aluminium. Preferably the sponge metal catalyst contains from 1 to 30% of the leachable metal, more preferably from 1-15%. When the skeletal metal comprises a major proportion of nickel then it is usual for the leachable metal content in the finished catalyst to be up to about 15% by weight. When other skeletal metals are used, the amount of leachable metal in the finished catalyst is normally less, and may be <5% when the skeletal metal is copper or cobalt, for example. An additional skeletal metal may be present up to about 20% by weight of the skeletal metal as described above.

The sponge metal catalyst particles are washed with water to remove the alkali metal aluminate. Washing is normally continued until a pH of between about 9 and about 12.5 is achieved. It is preferred that the washing is conducted under an inert (e.g. N₂ or Ar) atmosphere or one having a dilute concentration (2-8%, preferably 3-5%) of hydrogen. The catalyst is then normally stored under water in order to avoid contact with air. This is because sponge metal catalysts have a high metal surface area and are therefore pyrophoric in air. The sponge metal catalyst product normally has a pore volume (Nitrogen-BET) of from about 0.05 to about 0.3 cc/g; an average pore diameter ranging from about 10 to 500 Angstroms; a surface area (BET) of at least 10 m²/g and preferably ranging from about 20 to about 150 m²/g.

Preferably the catalyst comprises from 0.01 to 5%, more preferably from 0.05 to 2% and especially from 0.1 to 1% by weight of the first promoter metal. Preferably the catalyst comprises from 0.01 to 5%, more preferably from 0.05 to 2% and especially 0.1 to 1% by weight of the second promoter metal.

The sponge metal catalyst is preferably in the form of particles which are of a size from 1 to 150 microns. The first and second promoter metals may be uniformly distributed throughout the catalyst mass but preferably the promoter metals are concentrated at the surface of the catalyst mass.

US-B-6,309,758 describes a precious metal doped porous metal catalyst is disclosed in which the precious metal is present in from 0.01 to 1.5 weight percent and distributed throughout the particles of porous metal to provide a surface to bulk ratio of not greater than 60. Surface to bulk ratio (S/B) refers to the ratio of surface dopant concentration to bulk dopant concentration, where surface dopant concentration is the atomic ratio of first promoter metal to skeletal metal within the surface volume of a catalyst particle and bulk dopant concentration refers to the atomic ratio of first promoter metal to skeletal metal for the entire catalyst particle. Surface volume refers to the outer volume or shell of a catalyst particle of the present invention which is roughly the outer 50 Å of the particle's radius (i.e., extending from the outer surface of the particle inward toward the centre of the particle by about 50 Å).

In a preferred embodiment of the present invention, the S/B ratio is greater than 60, more preferably greater than 100, e.g. from 100 to 500, most preferably greater than 200, e.g. from 200 to 500.

The deposition of the first and second metal compounds on the surface of the sponge metal catalyst is preferably out by a process of impregnation of the sponge metal with a solution of the promoter metal compound, but may alternatively be carried out by a process of precipitation of the promoter metal compound from a solution of a metal compound. The deposition of each of the first and second metal compounds may be carried out by similar or different methods. In a preferred method of the invention, the promoter metals may be added to the catalyst by means of post-impregnation, i.e. by impregnating a formed sponge metal catalyst with a solution of a salt or complex of each of the promoter metals together or separately. Alternatively, the promoter metals, or a promoter metal compound may be precipitated onto the skeletal metal from a solution of a salt or complex of each of the promoter metals together or separately. Precipitation methods are well known in the art and include pH-controlled precipitation by formation of an insoluble compound from a solution of a soluble compound by mixing with a (typically alkaline) precipitant. Alternatively the promoter metals may be incorporated with the skeletal metal in the alloy with the leachable metal. As a further alternative, the promoter metal may be added to the caustic leaching solution used in the preparation of the sponge metal. All of these methods are known in the art. The catalyst of the invention contains both a first and a second promoter metal. The first and second promoter metals may be added to the catalyst by different methods at different stages of the process for preparing the catalyst, or they may be added using similar methods and at or about the same stage of preparation. Solutions of metal salts and complexes are preferably aqueous but organic solvents may be used.

In the preferred process of the invention, the first and second promoter metals are impregnated into the sponge metal catalyst. The second promoter metal may be impregnated into the sponge-metal catalyst before, after or simultaneously with the first promoter metal. The promoter metals are impregnated from a solution of a promoter metal salt. When the salt solutions are not compatible the impregnation of each promoter metal must be carried out as a separate step. When the solutions are compatible and may be mixed then the impregnation may be carried out in the same step using a mixed solution, or in separate steps using separate solutions. Normally aqueous solutions are used. Suitable salts include inorganic salts such as chlorides, nitrates, sulphates etc and organic salts, particularly the metal acetates. Examples of suitable salts used to form a solution of the first promoter metal include Pd(NO₃)₂ and Na₂PdCl₄. Examples of suitable salts used to form a solution of the second promoter metal include NaVO₃, ZnCl₂, FeCl₃.6H₂O, Ce(C₂H₃O₂)₃, AgNO₃ and Na₂VO₄. The sponge metal catalyst is contacted with the impregnating solution preferably for at least 5 minutes, normally for between 15 and 60 minutes with constant agitation. The pH of the slurry is preferably maintained above 8, more preferably above 9, during impregnation. The impregnation is normally done at room temperature although heating or cooling may be carried out if required. Following impregnation the catalyst is decanted from the impregnation solution and may be washed to remove free impregnation salts. The catalysts are stored in a non-oxidising atmosphere, e.g. in an inert gas such as N₂ or under water.

The catalysts of the present invention are useful in a variety of hydrogenation reactions. In particular the catalysts are useful for the hydrogenation of nitrobenzene to aniline, dinitrotoluene to toluenediamine and for the hydrogenation of organic nitrites to amines such as aliphatic fatty nitriles to primary amines or aliphatic dinitriles to diamines. The invention will be further described in the following examples which illustrate particular embodiments of the invention but which are not intended to limit the scope of the invention.

### Analysis

The bulk compositions of the sponge metal catalysts were determined by Inductive Coupled Plasma-Atomic Emission Spectroscopy (ICP-AES). The samples were dissolved with aqua regia solution. The Ni content was determined by difference, assuming the total contents of the elements are 100%.

The particle size of the catalysts was measured by laser scattering technique. The near-surface compositions of the catalysts were measured by X-ray Photoelectron Spectroscopy (XPS). Since sponge metal catalysts are highly activated, and thus pyrophoric, they self-ignite on exposure to air when dry so that the surface compositions may then be altered. To avoid oxidation of the catalyst during the sample transfer and measurement, all samples were placed in the copper sample holder in a fluid in the pre-treatment chamber. The water was then allowed to evaporate under dry N₂ stream over a two hour period to a vacuum of 3×10⁻⁷ Torr. The sample was then transferred into the analysis chamber without exposure to air. Al K radiation in a 500 μm spot at 150 W power was used to acquire the spectra. The binding energy was referenced to 284.8 eV of carbon 1s. The compositions were determined by using the sensitivity factors supplied by the manufacturer.

The S/B ratio was calculated in the same way as explained in U.S. Pat. No. 6,309,758 using the XPS measurement to determine surface composition and ICP-AES to determine the bulk composition. The S/B ratio =surface Pd/Ni divided by bulk Pd/Ni. The results are shown in Table 1.

### EXAMPLE 1

Preparation of a sponge nickel catalyst

Aluminium and nickel metals were heated, melted, and poured together to complete formation of an Al—Ni alloy containing about 50% Ni and 50% Al. The formed alloy was then cooled, crushed, ground and classified. The mean particle size of the powders was about 20- 25 μm. The powders were then added in small portions into a reactor containing about 30% NaOH solution. The slurry was agitated at about 90° C. for 4 hours. The slurry was then decanted to remove the supernatant and washed with water until the pH was <11.5. The activated catalyst was stored in the water medium. The assay result of the catalyst is shown in Table 1.

### EXAMPLE 2

Catalyst doped with palladium and vanadium

The sponge Ni catalyst prepared in Example 1 was used to make a promoted catalyst according to the invention. 0.2774 g of Na₂PdCl₄ salt (35.75 wt. % Pd) and 0.2375 g of NaVO₃ were dissolved in 50 cm³ of deionised water. 49.48 g of the base sponge Ni catalyst was charged into a 2-liter stainless steel beaker. The water surrounding the catalyst was decanted off and replaced with 500 cm³ of deionised water and the mixture was stirred at room temperature for 5 min to form a slurry having a pH of 10.3. While vigorously stirring, the metal salt solution was added into the sponge Ni catalyst slurry. The pH of the sponge Ni slurry was maintained above 9.3. The resulting catalyst was continuously stirred for about 30 min. The supernatant was decanted and analysed by inductively coupled plasma spectroscopy (ICP) to determine the Pd content. Pd was not detectable in the supernatant by ICP. The catalyst was washed with deionised water until no chloride was detected by testing with AgNO₃ solution. The pH of the final catalyst was adjusted to approximately 9.5. The catalyst was then stored under water.

### EXAMPLES 3-5

Catalyst samples were made in the same way as described in Example 2 except that zinc chloride, iron (III) chloride, and cerium acetate respectively were co-impregnated with Pd. The catalyst contained about 0.2% Pd and 0.2% of the second metal promoter. Table 1 shows the assay data (by ICP) of the catalysts.

### EXAMPLE 6

A catalyst sample was made by the general procedure of Example 2 using a mixed solution of AgNO₃ and Pd (NO3)₂. The final catalyst contained nominal 0.2% Pd and 0.2% Ag.

### EXAMPLE 7-10 (comparison)

As comparison, the same sponge Ni catalyst made in Example 1 was doped with palladium or the second metal only. The nominal Pd or the second metal promoter was about 0.2 wt %. The catalysts were prepared in the same way as in the Example 2, except that only one metal salt was used. In Example 8, the Pd salt was introduced at pH 6 by addition of acetic acid into the sponge Ni slurry. The compositions are shown in Table 1.

### EXAMPLE 11-12

Using the sponge nickel catalyst prepared in Example 1, the solutions of Na₂PdCl₄ salt (35.75 wt. % Pd) and 0.2375 g of NaVO₃ were separately dissolved in 50 cm³ of deionised water and then added to the sponge nickel slurry in sequence In Example 11, the palladium solution was added into the sponge Ni catalyst first, followed by addition of the vanadium solution. In Example 12, the vanadium solution was added into the sponge Ni slurry first, followed by addition of palladium salt solution. The resulting slurry was then decanted and washed, as the same way as in Example 2. The assay results are shown in Table 1.

### EXAMPLE 13

Hydrogenation of nitrobenzene to aniline was carried out at room temperature and 50 psi H₂ using the catalysts of Examples 1-10. The activity of each catalyst is shown in Table 1 expressed as ml H₂/min/g catalyst. It is clear that enhanced activity in this reaction was achieved when both Pd and a second metal salt was doped, i.e. using the catalysts of the invention, compared with catalysts containing either no promoter or only a single promoter metal.

### EXAMPLE 14-23

A sponge metal catalyst made by the method described in Example 1 was co-impregnated with palladium and a second metal promoter by the method used in Examples 2-5, with the exception that the pH of the catalyst was varied as shown in Table 2. The catalysts were tested for activity in the hydrogenation of nitrobenzene using the method described in Example 13 and the activity is shown in Table 2. All analysis, S/B ratio and activity is measured and calculated as described above.

TABLE 1

| | 1^{st} metal | 2^{nd} metal | Bulk Compositions by ICP(%) | | | | | Surface | | |
|---|---|---|---|---|---|---|---|---|---|---|
| | promoter | promoter | | | | | Pd/Ni | Pd/Ni | S/B | |
| Example | salt | salt (2M) | Pd | 2M* | Ni | Al | (Atom) | (XPS) | Ratio | Activity |
| 1 | — | — | | | 92.5 | 6.5 | 0 | 0 | NA | 127.2 |
| 2 | Na₂PdCl₄ | NaVO₃ | 0.20 | 0.20 | 92.1 | 6.5 | 0.00119 | 0.350 | 294 | 234.7 |
| 3 | Na₂PdCl₄ | ZnCl₂ | 0.21 | 0.20 | | | | 0.467 | 392 | 251.9 |
| 4 | Na₂PdCl₄ | FeCl3•6H₂O | 0.22 | 0.20 | | | | 0.346 | 285 | 208.3 |
| 5 | Na₂PdCl₄ | Ce(C₂H₃O₂)₃ | 0.20 | 0.30 | | | | NA | NA | 208.0 |
| 7** | Na₂PdCl₄ | | 0.22 | | | | | 0.435 | 365 | 60.3 |
| 8** | Na₂PdCl₄ | | 0.17 | | | | | 0.038 | 31.9 | 60.7 |
| 9** | | ZnCl₂ | | 0.20 | | | | NA | NA | 60.3 |
| 10** | | NaVO₃ | | 0.20 | | | | NA | NA | 75.5 |
| 11 | Na₂PdCl₄ | NaVO₃ | 0.21 | 0.20 | | | | NA | NA | 210.9 |
| 12 | Na₂PdCl₄ | NaVO₃ | 0.21 | 0.20 | | | | NA | NA | 234.5 |

*2M % is nominal concentration.
**Comparative experiment

TABLE 2

| | | Pd load | 2nd promoter | 2nd metal | S/B | |
|---|---|---|---|---|---|---|
| Example | pH | (wt %) | metal | (wt %) | Ratio | Activity |
| 14 | 8.07 | 0.20 | Ce | 0.20 | 83 | 117 |
| 15 | 8.55 | 0.20 | Ce | 0.20 | 177 | 57 |
| 16 | 8.01 | 0.20 | Cu | 0.20 | 53 | 106 |
| 17 | 8.54 | 0.20 | Cu | 0.20 | 100 | 26 |
| 18 | 8.09 | 0.20 | V | 0.20 | 56 | 198 |
| 19 | 8.53 | 0.20 | V | 0.20 | 25 | 202 |
| 20 | 10.17 | 0.20 | V | 0.20 | 142 | 236 |
| 21 | 7.98 | 0.20 | Zn | 0.20 | 196 | 142 |
| 22 | 8.53 | 0.20 | Zn | 0.20 | 258 | 127 |
| 23 | 9.55 | 0.20 | Zn | 0.20 | 214 | 252 |

### EXAMPLE 24

The catalysts of Examples 1 and 2 were tested in the hydrogenation of dinitrotoluene (DNT) to toluenediamine (TDA). The reactions were carried out in a continuous stirred tank reactor at a temperature of 143° C., a hydrogen pressure of 220 psig using a catalyst charge of 41 mg and a feed solution of DNT in methanol containing 53 mg DNT/ml. Test results shown in Table 3 show deactivation of the reference non-promoted catalyst of Example 1 at a productivity level of 677 g DNT per g of catalyst of Example 1. The 0.2/0.2 Pd/V co-promoted catalyst of Example 2, by contrast, shows a productivity in excess of 3060 g DNT per gram catalyst. This represents an improvement in lifetime of 4.5 times.

TABLE 3

| | | Batch | | | |
|---|---|---|---|---|---|
| | | Reaction | | | |
| | Flow | Rate | LHSV | | |
| | Rate, | (mmol | (g/g | Selectivity | Productivity |
| Catalyst | (ml/min) | H₂/min) | cat/hr) | (%) | (g DNT/g cat) |
| Example 1 | 0.7 | 0.68 | 52.5 | 97.4 | 677 |
| Example 2 | 0.7 | 0.78 | 52.5 | 99.4 | 3060+ |

1. A catalyst composition comprising:
(i) at least one skeletal porous sponge metal selected from the group consisting of nickel, cobalt, iron and copper;
(ii) a first promoter metal selected from the group consisting of palladium, platinum, ruthenium, rhodium, osmium and iridium; and
(iii) a second promoter metal selected from the group consisting of iron, nickel, cobalt, zinc, vanadium, cerium, copper, tungsten, molybdenum, titanium, niobium, manganese, silver, cadmium, praseodymium and neodymium.

2. A catalyst according to claim 1, wherein the first promoter metal is selected from the group consisting of Pt, Pd and Rh.

3. A catalyst according to claim 1, wherein the second promoter metal is selected from the group consisting of V, Fe, Ce and Zn.

4. A catalyst according to claim 1, wherein the at least one skeletal metal further comprises a second metal selected from the group consisting of titanium, chromium, zirconium, vanadium, molybdenum, manganese and zinc in an amount of 0-20% by weight of the total skeletal metal.

5. A catalyst according to claim 1, wherein the catalyst comprises from 0.01 to 5% by weight of the first promoter metal.

6. A catalyst according to claim 1, wherein the catalyst comprises from 0.01 to 5% by weight of the second promoter metal.

7. A catalyst according to claim 1, wherein the catalyst is in the form of particles which have an average diameter in the range from 1 to 150 microns.

8. A catalyst according to claims 1, wherein the distribution of promoter metals through the catalyst particles provides an S/B ratio in the range from 100 to 500,
where S/B ratio means the ratio of surface dopant concentration to bulk dopant concentration,
where surface dopant concentration is the atomic ratio of first promoter metal to skeletal metal within the surface volume of a catalyst particle,
bulk dopant concentration refers to the atomic ratio of first promoter metal to skeletal metal for the entire catalyst particle, and
surface volume refers to the outer volume of a catalyst particle which extends from the outer surface of the particle inward toward the centre of the particle by 50 Å.

9. A method for manufacuring a catalyst composition comprising the steps of:
a) forming a sponge metal catalyst in which tean active skeletal metal is selected from at least one of nickel, cobalt, iron and copper and from 0-20% by weight of a metal selected from the group consisting of titanium, chromium, zirconium, vanadium, molybdenum, manganese and zinc;
b) depositing upon La surface of said sponge metal catalyst at least one compound of a metal selected from the group consisting of palladium, platinum, ruthenium, rhodium, osmium and iridium; and
c) depositing upon the surface of said sponge metal catalyst at least one compound of a metal selected from the group consisting of iron, nickel, cobalt, zinc, vanadium, cerium, copper, tungsten, molybdenum, titanium, niobium, manganese, silver, cadmium, praseodymium and neodymium.

10. A method for manufacturing a catalyst according to claim 9, wherein step (b) is carried out before step (c).

11. A method for manufcturing a catalyst according to claim 9, wherein step (c) is carried out before step (b).

12. A method for manufacturing a catalyst according to claim 9, wherein step (b) and step (c) are carried out in the same process step.

13. A method according to claim 9, wherein steps (b) and (c) comprise impregnation of said sponge metal catalyst with a solution of a compound of said metals.

14. A method according to claim 9, wherein steps (b) and (c) comprise precipitation of said metal compound from a solution of a compound of said metals.

15. A method for manufacturing a catalyst composition comprising the steps of:
a) forming an alloy comprising from 70-40% wt of a leachable metal, from 30-60% wt of at least one active skeletal metal selected from the group consisting of at least one of nickel, cobalt, iron and copper, and at least one of
(i) a first promoter metal selected from the group consisting of palladium, platinum, ruthenium, rhodium, osmium and iridium and
(ii) a second promoter metal selected from the group consisting of iron, nickel, cobalt, zinc, vanadium, cerium, copper, tungsten, molybdenum, titanium, niobium, manganese, silver, cadmium, praseodymium and neodymium;
b) grinding said alloy into particles having an average size of from 1 to 500μ;
c) contacting said particles with a- solution of an alkali metal hydroxide for sufficient time and under conditions suitable to effect leaching of at least 80% of said leachable metal from the alloy to form a sponge metal catalyst; and optionally
d) depositing on a surface of said sponge metal catalyst a compound of at least one of
(i) a first promoter metal selected from the group consisting of palladium, platinum, ruthenium, rhodium, osmium and iridium and
(ii) a second promoter metal selected from the group consisting of iron, nickel, cobalt, zinc, vanadium, cerium, copper, tungsten, molybdenum, titanium, niobium, manganese, silver, cadmium, praseodymium and neodymium.

16. A method for manufacturing a catalyst according to claim 15, wherein at least one of steps d(i) and d(ii) comprise impregnation of said sponge metal catalyst with a solution of a compound of said metal.

17. A method for manufacturing a catalyst according to claim 15, wherein at least one of steps d(i) and d(ii) comprise precipitation of said metal compound from a solution of a compound of said metal.

18. A process for hydrogenating of an organic nitro compound or nitrile to a corresponding amine wherein the process is carried out in the presence of a catalyst as claimed in claim 1.

19. A process according to claim 18, comprising the hydrogenation of nitrobenzene to aniline, a nitrotoluene to a corresponding aminotoluene, dinitrotoluene to toluenediamine, an aliphatic nitrile to an aliphatic primary amine or of an aliphatic dinitrile to an aliphatic diamine.
